(19) United States
(12) Patent Application Publication
(10) Pub. No.: US 2015/0273373 A1
(43) Pub. Date: Oct. 1, 2015

(54) METHOD FOR REGENERATING FILTERS, PARTICULARLY FOR PARTICULATE FILTERS OF THE FAP OR DPF TYPE, WITH OR WITHOUT SECTIONS WITH CATALYSTS, AND APPARATUS FOR PERFORMING THE METHOD

(71) Applicant: MOVENGINEERING S.R.L., Parre (IT)

(72) Inventors: Mario MIGNANI, CASNIGO (IT); Fabio BERGAMINI, ARDESIO (IT)

(73) Assignee: MOVENGINEERING S.R.L., PARRE (IT)

(21) Appl. No.: 14/585,901

(22) Filed: Dec. 30, 2014

(30) Foreign Application Priority Data
Apr. 1, 2014 (IT) MI2014A000563

(51) Int. Cl. B01D 41/04

(52) U.S. Cl. CPC B01D 41/04

(57) ABSTRACT

A method for regenerating filters, particularly for particulate filters of the FAP or DPF type, with or without sections with catalysts, and an apparatus for performing the method. The method consists in striking the filters with a flow of a process fluid constituted by water vapor or by air to and/or by a mixture of water vapor and air at a process temperature of at least 300° C.

The present invention relates to a method for regenerating filters, particularly for particulate filters of the FAP or DPF type, with or without sections with catalysts, and to an apparatus for performing the method.

As is known, particulate filters, both of the FAP type (Filtres à Particules) and of the DPF type (Diesel Particulate Filter), are used to reduce the quantity of fine particles emitted, through exhaust gases, mainly from diesel-fueled internal combustion engines, such as for example automotive engines.

These filters, with use, become clogged with particulate, reducing their filtration efficiency and increasing the load losses along the exhaust duct of the engine, penalizing its performance.

For this reason, particulate filters both of the FAP type and of the DPF type must be subjected periodically to “regeneration” methods that can be of the standard type or of the extraordinary type.

Standard regeneration methods are usually performed automatically by a program that manages the operation of the engine, while extraordinary regeneration methods, which are used when the standard procedures are insufficient, require the removal of the enclosure or container, also known as a vessel or housing, that contains the filter, from the exhaust duct of the engine.

Standard regeneration, in the FAP system, is based on the use of a catalyzing additive, cerium oxide, also called “ceria”, which is mixed with the diesel fuel and lowers the particulate oxidation temperature, and upon a particular actuation of the engine, based on a boosting or post-combustion, that raises the temperature of the exhaust gases. Thanks to the use of the catalyzing additive, it is sufficient to bring the exhaust gases to a temperature of around 450° C. in order to obtain the complete combustion of the particles of particulate (soot), which are converted into gas, which is released in the atmosphere, and into a small quantity of ash, which accumulates in the filter.

In the DPF system, which does not use catalyzing additives for diesel fuel, in order to obtain the complete combustion of the particles of particulate, the temperature of the exhaust gases, by way of a particular actuation of the engine, based on a boosting or post-combustion, must be increased to approximately 600° C.-650° C.

In some types of filter, inside the container or housing, a filter is arranged with at least one filtering part or section with a catalyst. This case is more properly described as a “filter-catalyst assembly”.

When standard or automatic regeneration is no longer sufficient to obtain a suitable cleaning of the filter or the filter-catalyst assembly, it is necessary to proceed with regeneration of the extraordinary type, i.e., with a true maintenance intervention.

Extraordinary regeneration is aimed at the deep cleaning of the surface and of the pores of the filter or of the filter-catalyst assembly so as to return the differential pressure (the pressure drop between the intake and the outflow of the filter or of the filter-catalyst assembly) and the efficiency of the regenerated elements to the as-new values. This efficiency is measured as: a) differential pressure upon the passage of a known flow of gas; b) weight of the filter itself; c) suppression efficiency of the particulate and of the gases that are not completely oxidized, leaving the physical and chemical characteristics and the porosity of the filter or of the filter-catalyst unaltered.

Currently, extraordinary regeneration is performed in various ways including:
pouring chemical solutions into the filter;
removing the monolith, i.e., the ceramic or steel filtering body of the filter, from the container or housing and scrubbing it with chemical detergents;
associating the scrubbing with chemical detergents with other actions such as ultrasound, scrubbing with high-pressure liquids, flushing with air at high temperature;
removing the monolith from the container or housing and bringing it to a high temperature in an oven so as to obtain a deep oxidation of the particulate accumulated in the monolith and then removing the ashes with mechanical actions and/or scrubbings.

In the methods that use chemical substances, besides their cost, there are problems with the disposal of the chemical substances once they have been used. Generally, the use of these substances is subject to strict rules and their disposal requires treatments that have costs that considerably affect the overall costs of these methods.

In the methods that require the disassembly of the monolith of the filter or filter-catalyst, there are considerable times and therefore considerable costs for the disassembly and reassembly operations. Moreover, these methods generally require the use of specialist personnel.

The aim of the present invention is to solve the problems shown above, by devising a method for the regeneration of filters, particularly for particulate filters of the FAP or DPF type, with or without sections with catalysts, which achieves a high level of effectiveness in the regeneration despite using substances that are easy to dispose of.

Within this aim, an object of the invention is to propose a method that does not require the extraction of the monolith of the filter from its container or housing.

Another object of the invention is to propose a method that offers adequate assurances against damage to the filter during the regeneration.

Another object of the invention is to propose a method that provides, as residues of regeneration, substances that are disposable simply and cheaply.

Another object of the invention is to propose an apparatus, which is simple to provide, for executing the method according to the invention.

This aim and these and other objects that will become better apparent hereinafter are achieved by a method for regenerating filters, particularly for particulate filters of the FAP or DPF type, with or without sections with catalysts, which is characterized in that it consists in striking the filters with a flow of a process fluid constituted by water vapor or by air and/or by a mixture of water vapor and air, at a process temperature of at least 300° C.

The method according to the invention is preferably performed with an apparatus, characterized in that it comprises means for the adjustable supply of a process fluid composed of air or of water vapor or a mixture of air and water vapor, said adjustable supply means being connected to a supply duct that can be connected to an autoclave, which is adapted to receive the filters to be regenerated, or to an intake of at least one container or housing of a filter to be regenerated; along said supply duct there being at least one heater for said process fluid conveyed along said supply duct.

Further characteristics and advantages of the invention will become better apparent from the description of two preferred but not exclusive embodiments of the method according to the invention and of an apparatus for performing it, which are illustrated by way of non-limiting example in the accompanying drawings, wherein:

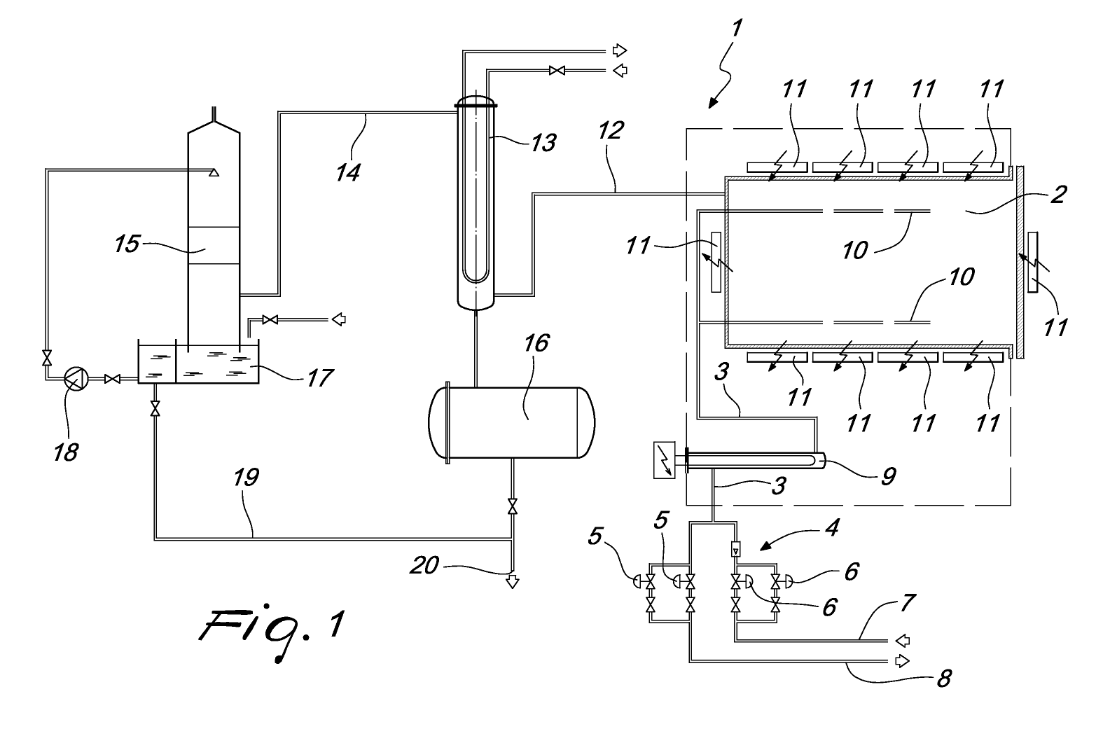

FIG. 1 is a schematic view of a first embodiment of the apparatus for performing the method according to the invention;

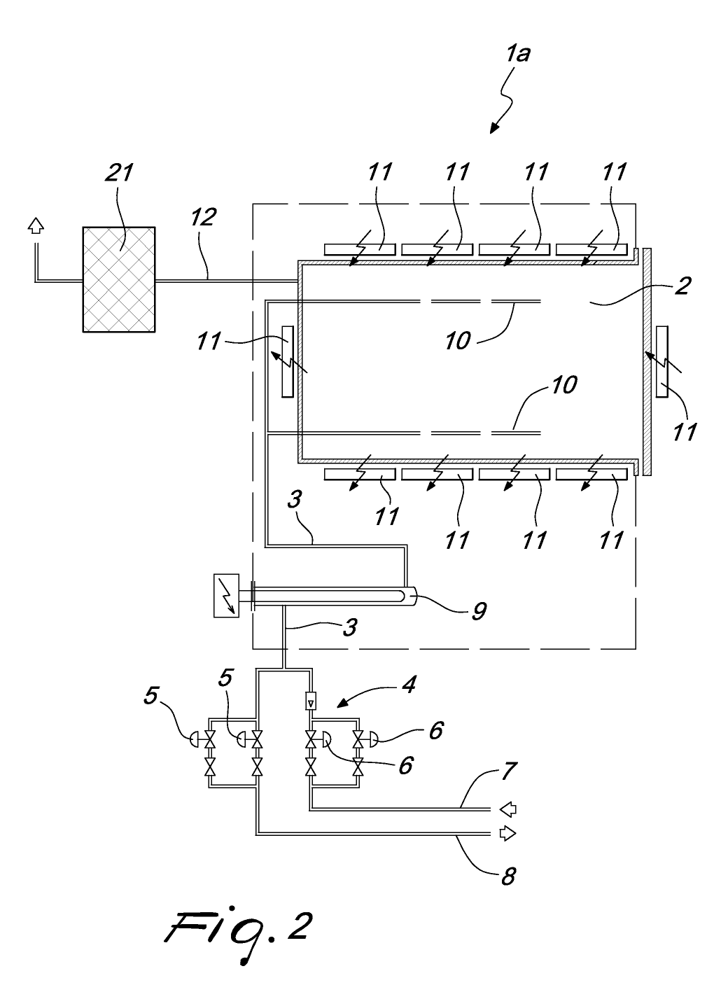

FIG. 2 is a schematic view of a variation of the first embodiment of the apparatus for performing the method according to the invention;

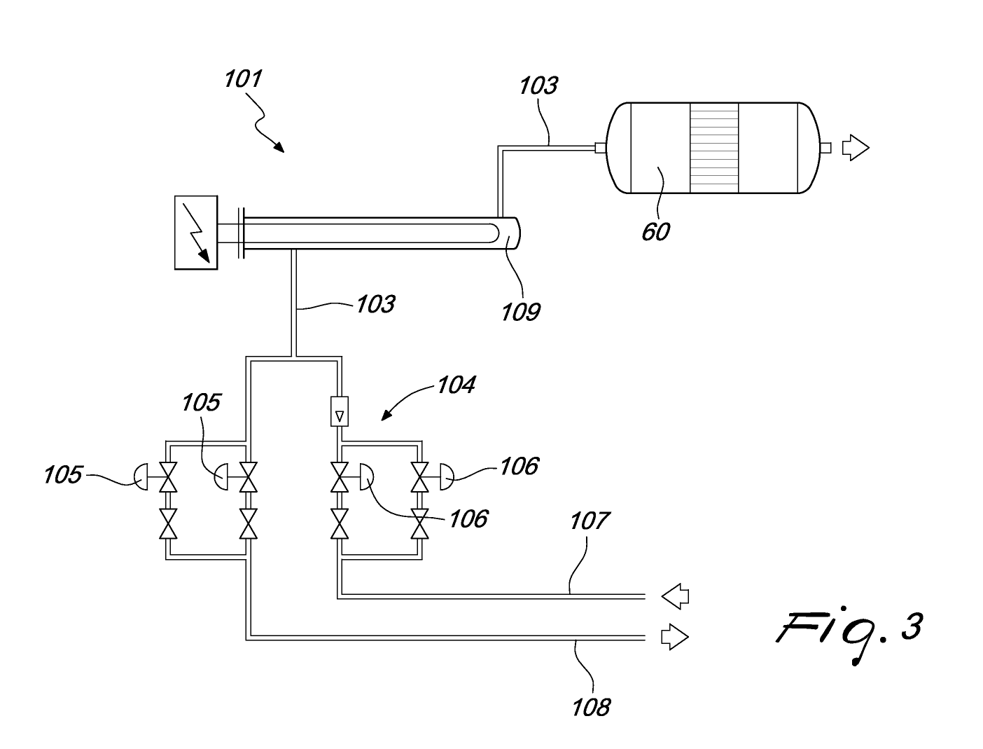

FIG. 3 is a schematic view of a second embodiment of the apparatus for performing the method according to the invention.

For the sake of simplicity in description, hereinafter the expression “filter” is understood to mean the filtering element, also known as “monolith”, made of ceramic or metallic material, placed inside a container or housing, with or without the addition of catalysts. Moreover, the term “vapor” is understood to mean water vapor.

With reference to FIG. 1, the apparatus for performing the method according to the invention, in the first embodiment, generally designated by the reference numeral 1, comprises an autoclave 2, which is adapted to receive the filters to be cleaned and is connected in input to a supply duct 3 that is connected to means for the adjustable supply 4 of a process fluid constituted by air or by vapor or by a mixture of air and vapor.

The adjustable supply means 4 comprise actuation and adjustment means that can be actuated manually or in an automated manner by way of an actuation and control body of the electronic type that oversees the operation of the entire apparatus according to preset programs. Such actuation and adjustment means can be constituted by valves or solenoid is valves 5, 6, by way of which the supply duct 3 can be connected, with the possibility to vary flow-rates and pressure, to an air supply line 7 and/or to a vapor supply line 8.

Along the supply duct 3, between the adjustable supply means 4 and the autoclave 2, there is a heater 9, which can be constituted by a heater of known type, for example of the electric type, in order to superheat the process fluid that is supplied to the autoclave 2 through the supply duct 3.

The supply duct 3 supplies one or more diffusers 10, for example diffusers with holes of known type, which are arranged inside the autoclave 2 and obtain a uniform distribution of the process fluid.

Preferably, there are means for heating the walls of the autoclave 2. These heating means can be constituted by heating means of known type, such as for example electric resistance heaters 11 applied to the walls of the autoclave 2, or by other heating means of known type.

The autoclave 2 is connected, in output, to a discharge duct 12, through which the process fluid, with the particles removed from the filters subjected to regeneration inside the autoclave 2, is removed. The discharge duct 12 is connected to a heat exchanger-condenser 13 that is supplied with water, with a temperature suitable to cause the condensation of the fluid in output from the autoclave 2. The output duct 14 of the heat exchanger-condenser 13 is connected to the intake of a scrubbing tower 15, of known type, for scrubbing the gases in output from the heat exchanger-condenser 13.

The bottom of the heat exchanger-condenser 13 is connected to a tank 16, in which the condensate deriving from the cooling performed inside the heat exchanger-condenser 13 is collected.

The scrubbing tower 15 is provided with a storage vat 17 for the scrubbing water that can be optionally recirculated by way of a pump 18. The drain of such storage vat 17 is connected, through a duct 19, to the drain 20 of the tank 16.

In the constructive variation of the apparatus shown in FIG. 2, in which the apparatus has been designated generally by the reference numeral 1a, the apparatus is provided substantially as in the first embodiment and, for this reason, the components of the apparatus that correspond to those already described with reference to FIG. 1 have been designated by the same reference numerals. Unlike the embodiment shown in FIG. 1, in the constructive variation shown in FIG. 2, a mechanical filter 21 for dust suppression is arranged along the exhaust duct 12 of the autoclave 2.

In the second embodiment, shown in FIG. 3, the apparatus for performing the method according to the invention, generally designated by the reference numeral 101, instead of comprising an autoclave in which the filters to be subjected to the treatment are intended to be arranged, comprises simply means for the adjustable supply 104 of a process fluid composed of air or of vapor or of a mixture of air and vapor, which are connected to a supply duct 103 that can be connected directly to the intake of at least one container or housing 60 of a filter to be regenerated. Obviously, the supply duct 103 can be provided with multiple branches in order to treat multiple filters simultaneously.

The adjustable supply means 104 for the process fluid can be constituted by control and adjustment means, such as valves or solenoid valves 105, 106, by way of which the supply duct 103 can be connected, with the possibility to vary the pressure and the flow-rates fed into such supply duct 103, to an air supply line 107 and/or to a vapor supply line 108, similarly to the adjustable supply means 4 already described with reference to the first embodiment of the apparatus for performing the method according to the invention.

Similarly to what has already been described with reference to the first embodiment of the apparatus for performing the method according to the invention, along the supply duct 103 there is a heater 109.

In this second embodiment, the supply duct 103 can be connected to is the intake port of the container or housing 60 of a filter to be regenerated while the output port of the container or housing 60 of the filter to be regenerated can be connected to a line for treating the process fluid in output in order to suppress the substances that are removed from the filter and conveyed by the process fluid.

Operation of the apparatus, in the two embodiments described above, in the execution of the method according to the invention is as follows.

The filters to be subjected to treatment, still contained in the corresponding container or housing, are placed inside the autoclave 2, if an apparatus in the first embodiment is used, or are connected with their intake port directly to the supply duct 103, if an apparatus in the second embodiment is used.

By acting appropriately on the adjustable supply means 4, 104, i.e., on the solenoid valves 5, 6, 105, 106, in the supply duct 3, 103 a process fluid is introduced which, depending on the various steps of the method, can be vapor or air or a mixture of air and vapor, at a process temperature that is at least 300° C. Preferably, the process temperature is comprised substantially between 300° C. and 650° C.

Even more preferably, the process temperature is comprised substantially between 400° C. and 600° C.

More particularly, the adjustable supply means 4, 104 are driven so as to perform, in sequence, preferably: a first, heating step, in which the filters, arranged inside the autoclave 2 or connected directly to the supply duct 103, are subjected to a flow of superheated vapor; a cleaning step, in which the filters are subjected to a flow of vapor or of a mixture of air and vapor at the to process temperature; a finishing step, in which the filters are subjected to a flow of air substantially at the process temperature; and a cooling step, in which the filters are subjected to a flow of air.

The cleaning step can have a duration that varies according to the type of filter to be treated and its degree of clogging.

Conveniently, in order to avoid excessive stresses that might damage the filters subjected to treatment, particularly if they are made of ceramic material, during the heating step the temperature of the process fluid is increased progressively until it is brought to the process temperature and, during the cooling step, the temperature of the process fluid is lowered progressively until it is brought to a temperature proximate to the ambient temperature or in any case to a temperature that ensures the integrity of the filters.

If an apparatus in the first embodiment, i.e., provided with an autoclave 2, is used, the supply pressure of the vapor and/or of the air is adjusted so as to obtain, inside the autoclave 2, during the treatment, a pressure comprised substantially between 0.3 and 4 ata (atmosphere absolute).

The treatment fluid, together with the particles and the substances that are removed from the filters, in output from the autoclave 2 or from the container or housing 60 of the filter, is subjected to a treatment for suppressing the substances that might damage the environment, for example by way of condensation and scrubbing in the heat exchanger-condenser 13 and in the scrubbing tower 15, or to other treatments of known type.

Essentially, with the method according to the invention, the filters to be regenerated, which are dirty with ash, combustion dust, carbon-containing aggregates, and unburnt organic substances, are struck with a high-temperature stream of water vapor, of an adjustable mixture of air and vapor, and/or of air at high temperature, which performs an action of scrubbing, of hydrolysis, of solution, of oxidation and of vaporization of the contaminants present on the surface in the pores of the filtering element, which ensures an effective regeneration of the filters.

It should be noted that with the method according to the invention the monoliths of the filters, in order to be subjected to treatment, do not need to be removed from the corresponding container or housing. In this manner, is the time and therefore the costs required for the regeneration treatment are reduced considerably.

Moreover, in this manner also the integrity of the filter is assuredly safeguarded.

In practice it has been found that the method according to the invention fully achieves the intended aim and objects, since it makes it possible to obtain high level of effectiveness in the regeneration of filters, particularly of particulate filters of the FAP or DPF type, despite using substances, such as water vapor and air, that are easy and cheap to dispose of after use.

Another advantage of the method according to the invention is that it enables the execution of the regeneration of filters without having to disassemble the monolith from the container or housing, thus obtaining a reduction of the overall treatment times and a simplicity of execution that is such as to not necessarily require the intervention of specialist personnel.

The method and the apparatus for its execution thus conceived are susceptible of numerous modifications and variations, all of which are within the scope of the appended claims; all the details may furthermore be replaced with other, technically equivalent elements.

In practice, as regards the apparatus, the materials used, as well as the dimensions, may be any according to the requirements and the state of the art.

The disclosures in Italian Patent Application No. MI2014A000563 from which this application claims priority are incorporated herein by reference.

What is claimed is:

1. A method for regenerating filters, particularly for particulate filters of the FAP or DPF type, with or without sections with catalysts, comprising the step of striking filters with a flow of a process fluid constituted by water vapor or by air and/or by a mixture of water vapor and of air at a process temperature of at least 300° C.

2. The method according to claim 1, wherein said filters are kept in a corresponding container or housing.

3. The method according to claim 1, wherein said filters are placed in an autoclave.

4. The method according to claim 1, wherein pressure inside said autoclave during the treatment is comprised substantially between 0.3 and 4 ata (atmosphere absolute).

5. The method according to claim 3, wherein walls of said autoclave is are heated to a temperature that is substantially equal to said process temperature.

6. The method according to claim 2, wherein the container or housing of said filters is connected by way of one of the intakes thereof to a duct for supplying the process fluid.

7. The method according to claim 1, wherein said process temperature is comprised substantially between 300° C. and 650° C.

8. The method according to claim 1, wherein said process temperature is comprised substantially between 400° C. and 600° C.

9. The method according to claim 1, further comprising:
a first, heating step, in which the filters are subjected to a flow of water vapor;
a cleaning step, in which the filters are subjected to a flow of water vapor or of a mixture of air and water vapor at said process temperature;
a finishing step, in which the filters are subjected to a flow of air substantially at said process temperature;
a cooling step, in which the filters are subjected to a flow of air.

10. The method according to claim 9, wherein during said heating step the temperature of the water vapor flow is increased gradually until it is raised to said process temperature.

11. The method according to claim 9, wherein during said cooling step the temperature of the air flow is decreased progressively.

12. An apparatus for regenerating filters, particularly for particulate filters of the FAP or DPF type, with or without sections with catalysts, comprising means for the adjustable supply of a process fluid composed of air or of water vapor or of a mixture of air and water vapor, said adjustable to supply means being connected to a supply duct that can be connected to an autoclave, adapted to receive the filters to be regenerated, or to an intake of at least one container or housing of a filter to be regenerated; along said supply duct there being at least one heater for said process fluid conveyed along said supply duct.

13. The apparatus according to claim 12, wherein said adjustable supply means comprise control and adjustment means for connecting said supply duct to an air supply line and/or to a water vapor supply line.

14. The apparatus according to claim 12, further comprising means for heating walls of said autoclave.

15. The apparatus according to claim 12, further comprising treatment means for treating the fluid which are constituted by the process fluid and by the impurities removed from the filters, in output from said autoclave or from the container or housing of the filter.

16. The apparatus according to claim 15, wherein said treatment means comprise at least one heat exchanger-condenser for cooling and condensing said fluid in output from said autoclave or from the container or housing of the filter.

17. The apparatus according to claim 15, wherein said means for treating said fluid in output from said autoclave or from the container or housing of the filter comprise a tower for scrubbing the gases in output from said heat exchanger-condenser.

18. The apparatus according to claim 15, wherein said treatment means for treating said fluid in output from said autoclave or from the container or housing of the filter comprise a mechanical filter for suppressing the dust conveyed by said fluid in output from said autoclave or from the container or housing of the filter.
